(19) United States
(12) Patent Application Publication
(10) Pub. No.: US 2026/0081358 A1
(43) Pub. Date: Mar. 19, 2026

(54) ANTENNA USING EMBEDDED MTM-EBG UNIT CELLS

(71) Applicant: THE GOVERNORS OF THE UNIVERSITY OF ALBERTA, Edmonton (CA)

(72) Inventors: Ashwin IYER, Edmonton (CA); Braden Peter SMYTH, Edmonton (CA); Samuel CLARK, Edmonton (CA)

(21) Appl. No.: 19/217,642

(22) Filed: May 23, 2025

Related U.S. Application Data
(60) Provisional application No. 63/651,698, filed on May 24, 2024.

(51) Int. Cl. H01Q 15/00; H01Q 9/04

(52) U.S. Cl. CPC H01Q 15/0086; H01Q 9/0407

(57) ABSTRACT

Disclosed examples generally relate to an antenna using embedded metamaterial based electromagnetic bandgap (MTM-EBGs) unit cells, and a method of fabricating thereof. In some examples, the antenna structure comprises: an inner patch; a plurality of metamaterial based electromagnetic bandgap (MTM-EBG) unit cells disposed along an outer perimeter of the inner patch, each unit cell being configurable between an activated state and a deactivated state, each unit cell comprising a two layer parallel plate capacitive arrangement defined by, a dielectric substrate extending between a first surface and a second surface along an extension axis, two first capacitive plates fabricated along the first surface and separated by a gap, and a second capacitive plate fabricated along the second surface and overlapping with the first capacitive plates in a direction along the extension axis.

### CROSS-REFERENCE TO RELATED APPLICATION(S)

This application claims the benefit of, and priority to, U.S. Provisional Patent Application No. 63/651,698, filed on May 24, 2024, which is incorporated herein by reference in its entirety.

### FIELD

The present invention generally relates to communication antennas, and more particularly, to an antenna using embedded metamaterial based electromagnetic bandgap (MTM-EBGs) unit cells, and a method of fabricating thereof.

### BACKGROUND

Global Navigation Satellite Systems (GNSS), such as the Global Positioning System (GPS) deployed by the United States, are used to accurately determine the location of terrestrial receivers. Global reliance on these systems has dramatically increased as receivers have reduced in size and price, and several billion devices worldwide now rely on precise location measurements. Common uses range from the mundane, include tracking human movement with smartphones and smart watches or locating objects as a part of the Internet of Things, to the critical, such as assistance in aircraft landing systems.

Current GPS systems broadcast right-hand circularly polarized (RHCP) signals at frequencies referred to as GPS L1 (1575.42 MHz), L2 (1227.60 MHz), and a recently introduced third band, L5 (1176.45 MHz); a bandwidth of +12 MHz around each frequency is required for P(Y)- and M-code reception, although smaller bandwidths are acceptable for civilian use with C/A code.

Operating a GPS receiver over several or all of these bands provides some distinct advantages. Multiple frequencies can be used to improve location accuracy by correcting errors such as those caused by propagation through the ionosphere, increase signal reliability particularly in the presence of multi-path interference, enhance real time kinematic (RTK) positioning, improving accuracy in difficult environments such as urban canyons, and making the user less vulnerable to interference, spoofing and jamming. Receivers may additionally operate over other GNSS systems including Europe's Galileo, Russia's GLONASS and China's BeiDou, further enhancing these advantages.

### SUMMARY

Disclosed examples generally relate to a compact antenna with good performance over at least two frequency bands (e.g., a dual-band antenna), but may include more frequency bands (e.g., a multi-band antenna).

The antenna is developed as a patch antenna and with the use of metamaterial based electromagnetic bandgap (MTM-EBGs) unit cells. The patch antenna is fabricated on two sides of a single substrate sheet above a ground plane. In some examples, a 3D printed polylactic acid (PLA) substrate spacer is used for simple fabrication. The antenna may be fed by a wideband and planar feed network below the ground plane. In at least one example, the disclosed antenna can be used with transmission and reception at global positioning system (GPS) frequencies. For instance, the antenna can be deployed with L1 and L2/L5 GPS frequencies (e.g., dual-band). Simulation and measurement show good performance for the antenna in terms of matching, gain, pattern shape, and axial ratio for all bands, rending this antenna an excellent candidate for use with modern high-accuracy GPS receivers.

In at least one broad aspect, there is provided an antenna structure comprising: an inner patch; a plurality of metamaterial based electromagnetic bandgap (MTM-EBG) unit cells disposed along an outer perimeter of the inner patch, each unit cell being configurable between an activated state and a deactivated state, each unit cell comprising a two layer parallel plate capacitive arrangement defined by, a dielectric substrate extending between a first surface and a second surface along an extension axis, two first capacitive plates fabricated along the first surface and separated by a gap, and a second capacitive plate fabricated along the second surface and overlapping with the first capacitive plates in a direction along the extension axis, wherein when the unit cells are deactivated, the inner patch is configured to resonate at a first frequency range, and when the unit cells are activated, the inner patch with the unit cells are configured to resonate at a second frequency range.

In some examples, the MTM-EBG unit cells are multi-layer cells (e.g., two layers).

In some examples, the antenna is a dual-band antenna or a multi-band antenna.

In some examples, the two first capacitive plates and the second capacitive plates together form two capacitors in series formation, and that may lie parallel to a gap capacitance formed by the two first capacitive plates.

In some examples, the inner patch is circular, and the unit cells are disposed azimuthally around an outer circular edge of the patch.

In some examples, the inner patch is rectangular, and the unit cells are disposed rectangularly on the outer edges of the patch.

In some examples, each MTM-EBG unit cell is configured with a passband frequency range that includes the second frequency range, and a stopband frequency range that includes the first frequency range.

In some examples, each MTM-EBG unit cell is activated when a signal in the second frequency range is applied to each unit cell, and is deactivated when a signal in the first frequency range is applied to each unit cell.

In some examples, the first frequency range include an L1 GPS frequency range, and the second frequency range includes an L2 and/or L5 GPS frequency range.

In some examples, the inner patch has a first diameter configured for resonating at the L1 frequency, and the MTM-EBG unit cells are deactivated at the L1 frequency range

In some examples, at the L2 or L5 frequency, the MTM-EBG unit cells are activated to produce an expanded patch having a second diameter configured to resonate at the L2 or L5 frequency, the second diameter being wider than then first diameter.

In some examples, the antenna comprises a patch portion that includes the inner patch and the plurality of MTM-EBG unit cells.

In some examples, the patch portion includes the dielectric substrate, and wherein the inner patch forms a portion of one of the first capacitive plates.

In some examples, the antenna further comprises a primary dielectric substrate having a first and second surface, and the patch portion is coupled to the first surface, and the second surface is coupled to a feed portion.

In some examples, the primary dielectric substrate is formed of polylactic acid (PLA).

In some examples, the feed portion comprises a ground plane and a feed network circuit.

In some examples, the feed portion comprises a secondary dielectric substrate, and the ground plane and feed network circuit are fabricated on opposing surfaces of the secondary dielectric substrate.

In some examples, least one feed pin couples between the feed network circuit and the inner patch.

In another broad aspect, there is provided a metamaterial based electromagnetic bandgap (MTM-EBG) unit cell comprising a two layer parallel plate capacitive arrangement defined by: a dielectric substrate extending between a first surface and a second surface along an extension axis, two first capacitive plates fabricated along the first surface and separated by a gap, and a second capacitive plate fabricated along the second surface and overlapping with the first capacitive plates in a direction along the extension axis, wherein the unit cell is deactivated when a signal in a first frequency range is applied, and activated when a signal in a second frequency range is applied.

In some examples, the entire capacitive plate structure is above a ground plane.

In some examples, the two first capacitive plates and the second capacitive plates together form two capacitors in series formation, and may lie in parallel with the gap capacitance of the first two capacitive plates.

In some examples, the unit cell is configured with a passband frequency range that includes the second frequency range, and a stopband frequency range that includes the first frequency range.

In another broad aspect, there is provided a method of fabricating an antenna structure comprising: fabricating a patch portion comprising an inner patch and a plurality of metamaterial based electromagnetic bandgap (MTM-EBG) unit cells disposed along an outer perimeter of the inner patch; fabricating a primary substrate; fabricating a feed portion comprising a ground plate layer and a feed network circuit; and coupling the patch portion and feed portion to opposing surfaces of the primary substrate.

In some examples, the substrate is formed of polylactic acid (PLA), a foam spacer (e.g., with the properties of air), or a gap between the patch and the ground plane to act as an air substrate.

In some examples, the substrate has a curved upper surface to which the antenna conforms, a curved lower surface to which the ground plane conforms, or both curved upper and lower surfaces to which the antenna and ground plane conform.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A illustrate various views of a single-band circular patch antenna configured for GPS L1 frequencies, including a side view and a top view.

FIG. 1B illustrate various views of a single-band circular patch antenna configured for GPS L2/L5 frequencies, including a side view and a top view.

FIGS. 2A-2B show plots for a single-band, single-resonance circular patch antenna, including with S-parameters of single-resonance antennas for operation over GPS L1 and L2/L5, with ±12 MHz bandwidths highlighted (FIG. 2A) and broadside axial ratio (AR) of single-band antennas with four versus two quadrature-phased pins (FIG. 2B).

FIGS. 3A-3C illustrate an upper patch portion of an antenna structure using MTM-EBG unit cells, including a top view (FIG. 3A), a bottom view (FIG. 3B) and a partially transparent top view (FIG. 3C) of the portion.

FIG. 4A illustrates a cross-sectional view of an antenna disclosed herein using MTM-EBG unit cells, and showing two circuit boards for the patch and feed/ground, and a PLA substrate, and taken along a cross-sectional line analogous to line 4-4′ in FIG. 1A.

FIG. 4B illustrates another similar cross-sectional view for another example antenna design using MTM-EBG unit cells.

FIGS. 5A-5B show a top view (FIG. 5A) and a cross sectional view (FIG. 5B) of an MTM-EBG circuit model (left) and printed realization using strip inductors and parallel-plate capacitors (right). Both MTM-EBG unit cells are connected to a parallel-plate waveguide (PPW) structure, and propagation is in the y-direction.

FIG. 5C shows another cross-sectional view of an MTM-EBG unit cell, and taken along a cross-sectional line analogous to line 4-4′ in FIG. 1A.

FIG. 6A shows a feed network including three quadrature hybrid couplers (QHCs) and a differential phase shifter (DPS), with signal phase at each node indicated.

FIG. 6B shows a layout of the feed network circuit for the disclosed GPS antenna using broadband components.

FIG. 6C shows various QHC and DPS parameters, with dimensions given in Table 1.

FIG. 7 shows an example method for fabricating a GPS antenna with MTM-EBG unit cells, as disclosed herein.

FIGS. 8A-8B illustrate a fabricated GPS antenna showing top view (FIG. 8A) with images of the underside of a patch and ground plane inset, and bottom view (FIG. 8B).

FIGS. 9A-9B shows various plots including a magnitude (dB) of S-parameters for one MTM-EBG unit cell (FIG. 9A), and a phase of S21 for a single unit cell (FIG. 9B).

FIG. 10A shows a plot of simulated Sₙₙ of GPS antenna, wherein n may be any of the four ports due to symmetry.

FIGS. 10B and 10C shows graphs of simulated patterns (FIG. 10B) and axial ratio at GPS operating frequencies (FIG. 10C).

FIG. 11 shows a plot of broadside RHCP gain of antenna versus ground plane size. Vertical dashed line indicates ground plane diameter ultimately chosen to accommodate feed network.

FIG. 12 shows a plot of simulated and measured reflection coefficient of GPS antenna with feed network.

FIG. 13 shows a plot of simulated broadside realized gain of an antenna with a feed network.

FIGS. 14A-14C show simulated and measured normalized radiation patterns of the GPS antenna on the xz- and yz-planes for L1 (FIG. 14A), L2 (FIG. 14B), and L5 (FIG. 14C).

FIGS. 15A-15C show simulated and measured AR patterns of the GPS antenna on the yz-plane for L1 (FIG. 15A), L2 (FIG. 15B), and L5 (FIG. 15C).

FIG. 16 shows the reflection coefficient and port-to-port isolation (FIG. 16A) and radiation patterns at L1, L2, and L3 (FIG. 16B) of the GPS antenna with an air dielectric and two-pin feed.

FIG. 17 shows a plot of broadside realized gain of GPS antenna with air dielectric and two-pin feed.

FIG. 18 shows radiation patterns of the GPS antenna with an air dielectric and four-fin feed, showing reduced cross-polarization as compared to FIG. 16B.

### DETAILED DESCRIPTION

Disclosed examples relate to an antenna using embedded metamaterial based electromagnetic bandgap structures (MTM-EBGs), and a method of fabricating thereof.

### I. General Overview

Current GPS systems broadcast right-hand circularly polarized (RHCP) signals at frequencies referred to as GPS L1 (1575.42 MHz), L2 (1227.60 MHz), and a recently introduced third band, L5 (1176.45 MHz); a bandwidth of +12 MHz around each frequency is required for P(Y)- and M-code reception, although smaller bandwidths are acceptable for civilian use with C/A code.

GPS receivers can operate over several bands in a small footprint-GPS antennas, on the other hand, are typically large (particularly in high-performance systems), bulky, and narrow-band, and their design is critical to the reception of multiple weak GPS signals. Low precision systems may use small antennas with poor performance characteristics, active antennas to boost gain, or assisted GPS (A-GPS) to improve detection speed, but these approaches do not offer high levels of accuracy or reliability.

In view of the foregoing, there is a desire for a wideband (or multiband) antenna structure that can operate in multiple bands and/or multiple GNSS systems, while accommodating design constrains. Design constraints include that the antenna should have simple fabrication for broad deployment.

Planar antennas are ubiquitous as they balance cost with good performance, and are also easily integrated into devices where a low profile is important. A drawback is that typical planar structures, such as microstrip patch antennas, are single-band and have a small bandwidth.

Over the years, however, patch antennas with sufficient bandwidth to cover all three GPS bands (e.g., L1, L2 and L5) have been developed. These antennas are typically either dual-band (with the lower band covering both L2 and L5) or wideband enough to cover the entire GNSS range, with many methods developed to achieve this. However, a challenge with these low-profile, wideband patch antennas is achieving right-hand circularly polarization (RHCP) at all frequencies, since patch antennas are often linearly polarized, or have circular polarization over only a small frequency range.

To this end, a recent technology used to render antennas multi-band is known as the “metamaterial-based electromagnetic bandgap structure” (MTM-EBG). The MTM-EBG structure is embedded directly into the patch itself to increase functionality without taking up any additional space, and the resulting antenna presents good radiating properties in both bands.

Accordingly, disclosed examples provide for a compact and low-profile dual-band antenna using MTM-EBG unit cells. The antenna consists of a patch layer with embedded MTM-EBG unit cells for dual-band operation.

In at least one example, the disclosed antenna is used as a GPS antenna, and can operate at GPS L1 and L2/L5 frequencies. The antenna covers L1 in an upper operating band, and L2 and L5 in a broad lower band, resulting in tri-band GPS coverage, as well as nearly full coverage of the GNSS spectrum which covers frequency ranges of 1164-1300 MHz and 1559-1610 MHz.

In some examples, the antenna also includes a polylactic acid (PLA) substrate that has an appropriate thickness to increase antenna bandwidth, and ensure the antenna bandwidth covers all three frequencies. The PLA substrate can be 3D printed. In at least one example, the patch antenna is combined with a wideband feed network, which feed into the patch using one or more ports (e.g., four ports). In some examples, the wideband feed network is designed to supply equal power division and quadrature phase to each respective port and is designed with broadband microstrip-based components. In some examples, the planar feed network produces appropriate circular polarization across the GNSS spectrum.

As provided herein, the resulting dual-band antenna—when used in GPS L1 and L2/L5 frequencies—is shown to have excellent performance in all three bands, with gain, pattern shape, and AR/MPR suitable to enable tri-band P(Y)-code GPS reception, and is also cheap to manufacture and robust. It is amenable to use with other GNSS constellations such as Galileo that additionally used the frequency band in between L2 and L5, since it operates over this entire bandwidth. This GPS antenna is particularly well-suited to applications with high multipathing, for example on vehicles in dense urban centers, or for military applications where jamming and spoofing are an operational risk.

### II. Singly-Banded Circular Patch Antenna

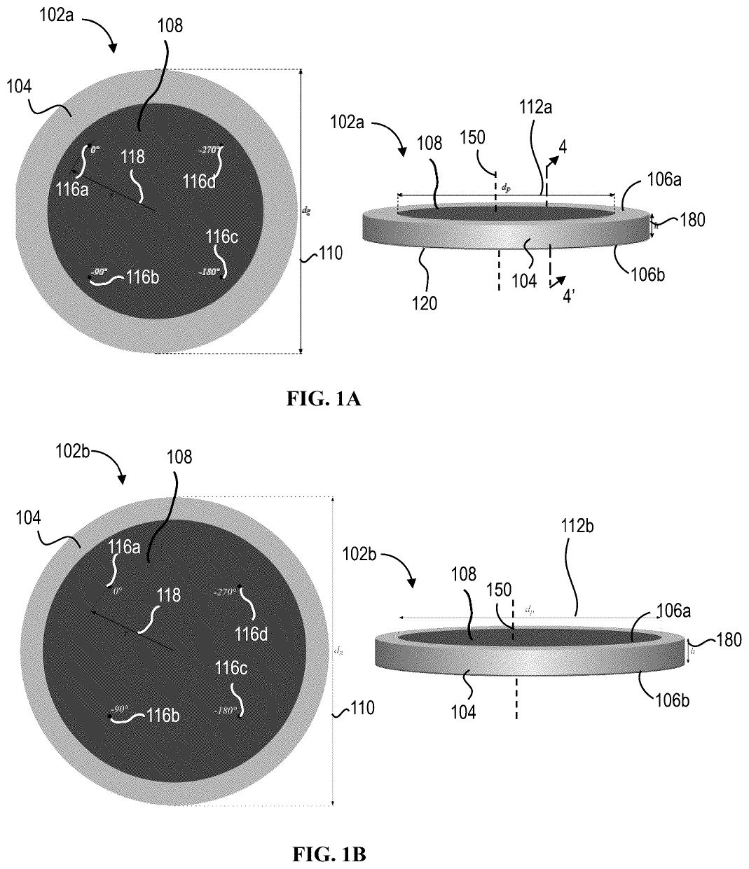

FIGS. 1A and 1B illustrate singly-resonant patch antenna designs 102a, 102b. The exemplified antenna designs can be configured to cover different bands based on adjustments to certain dimensional parameters. For instance, in one example, this includes covering either (i) GPS L1 (FIG. 1A), or (ii) GPS L2/L5 (FIG. 1B) frequencies, based on adjustments only to dimensional parameters.

As shown, a simple, single-band antenna (e.g., GPS antenna) can be constructed as a circular patch antenna 102 with an appropriate feed structure to support RHCP. The small bandwidth required for P-code reception allows the antenna to be small and compact if necessary, and of a low profile over a ground plane.

In this example, the patch antennas 102a, 102b are generally analogous in structure and each include a substrate 104 that extends between an upper surface 106a and an opposed lower surface 106b, along extension axis 150. While reference is made herein throughout to “upper” and “lower” for ease of explanation, it is understood that the disclosed examples are not limited to any particular orientation.

An axial distance between the upper and lower surfaces 104a, 104b defines a height dimension (h) 180 of the substrate 104. The substrate 104 itself has a cross-sectional diameter (d_{g}) 110, which is also the ground plate 120 diameter.

In at least one example, the substrate 104 is formed of (e.g., comprises) polylactic acid (PLA), which is a standard material used in 3D printing. The substrate can therefore be easily printed with a required thickness, and has good dielectric properties at microwave frequencies. In some examples, the PLA substrate is printed with an infill percentage of 100%, and can have a permittivity of ϵᵣ=2.64 (e.g., as measured using an open ended coaxial probe), as well as a loss tangent of this material is approximately tan(δ)=0.0071.

In other examples, the substrate may be formed of a foam spacer (e.g., with the properties of air), or a gap between the patch and the ground plane to act as an air substrate.

In some examples, substrate 104 has a curved upper surface to which the antenna conforms, a curved lower surface to which the ground plane conforms. In other cases, the substrate 104 has both curved upper and lower surfaces to which the antenna and ground plane conform.

As further shown, a patch 108 is disposed on the upper surface 106a of the substrate 104, and has a diameter dimension (dₚ) 112. The patch diameter (dₚ) 112 is less than the substrate diameter (d_{g}) 110.

In this example, the patch 108 is configured as a circular patch to accommodate transmission and reception of circularly polarized signals. Further, circular output polarization is achieved with the inclusion of four ports 116a-116d to excite the antenna during signal transmission. It will be understood that ports 116a-116d also act as input ports, during signal reception.

Ports 116 may be of equal angular spacing around the patch 108, with successive quadrature phase. For example, port 116a can have an output/input phase of 0°, port 116b can have an output/input phase of −90°, port 116c can have an output/input phase of −180°, and port 116d can have an output/input phase of −270°. In other examples, the antenna includes one or more ports 116, as desired.

In at least one example, the antennas 102 are dimensioned such that a common pin distance (r) 118 is defined from the radial center of the circular patch 108, to each port 116. In at least one example the common pin distance (r) is selected as 32.0 mm

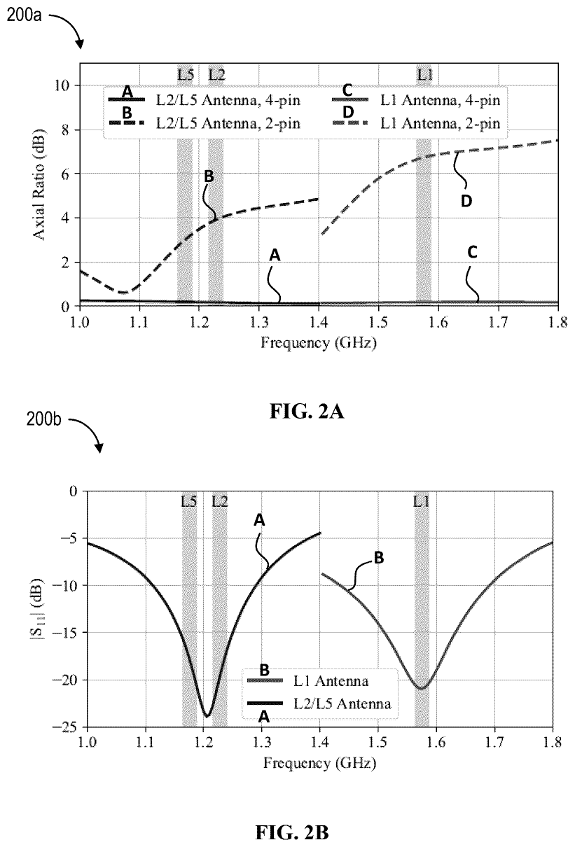

The broadside axial ratio (AR) of the exemplified antenna configuration using four pots 116 is presented in plot 200a of FIG. 2A. It is notable in plot 200a a very good AR is observed over a large bandwidth. By comparison, keeping the same antenna design but only using two quadrature-fed pins to excite the antenna results in severely reduced polarization purity, also shown in plot 200a of FIG. 2A. Therefore, while the use of four appropriately phased feed locations requires a more complex feed structure, it demonstrates substantially improved AR for the single-band antennas as a method of excitation. This is because the extra pins, in a four port configuration, enforce the appropriate phase conditions over the entire circumference of the antenna.

To this end, the L1 antenna (FIG. 1A) and the L2/L5 antenna (FIG. 1B) differ only in patch diameters (dₚ) 112a, 112b; all other parameters (d_{g}, h, r) remain fixed. Generally, the patch diameter (dₚ) 112b of the L2/L5 antenna 102b (FIG. 1B) is larger than the patch diameter (dₚ) 112a of the L1 antenna 102a (FIG. 1A). In at least one example, the L1 and L2/L5 antennas are selected with a patch diameter (dₚ) 112 being approximately 72.6 mm and 90.4 mm, respectively.

In some examples, each of the L1 and L2/L5 antennas are selected with a ground plane diameter (d_{g}) of 120 mm, and a substrate height (h) 108 of 8.5 mm to provide sufficient bandwidth for the lower frequency antenna to cover both L2 and L5; S-parameters for the antennas shown in plot 200b of FIG. 2B demonstrate this.

### III. MTM-EBG GPS Antenna

It has been appreciated that the L1 and L2/L5 antenna designs, exemplified in FIGS. 1A and 1B, are well-matched and show good performance over each of their individual bands, together covering all three GPS bands. Accordingly, examples herein provided for the use of “metamaterial-based electromagnetic bandgap” (MTM-EBG) unit cells to combine these antennas into a single antenna structure, as described herein.

As noted above, the circular patch diameter is smaller for the L1 than the L2/L5 antenna. As explained herein, the use of MTM-EBG unit cells allows for using a single patch 108 for both L1 and L2/L5 that can increase or decrease in the diameter by “activating” or “deactivating” MTM-EBG unit cells as a function of frequency. At the L1 frequencies, the MTM-EBG unit cells 304 have a band gap, such that the unit cells are “deactivated” and the circular patch 108 has a reduced diameter, and accommodating resonance of the patch at L1 frequencies. The MTM-EBG unit cells are further configured with a bandpass at the L2/L5 frequencies, which has the effect of the “activated” MTM-EBG unit cells effectively increasing the diameter of the circular patch 108 to accommodate resonance at L2/L5 frequencies.

Therefore, using the MTM-EBG unit cells, the two antennas in FIGS. 1A and 1B can effectively be combined to cover all three bands. The first operates at L1 frequency, and the second has sufficient bandwidth to operate at the combined L2 and L5 frequency. In at least one example, this requires the L2/L5 band to have a minimum of 6% bandwidth.

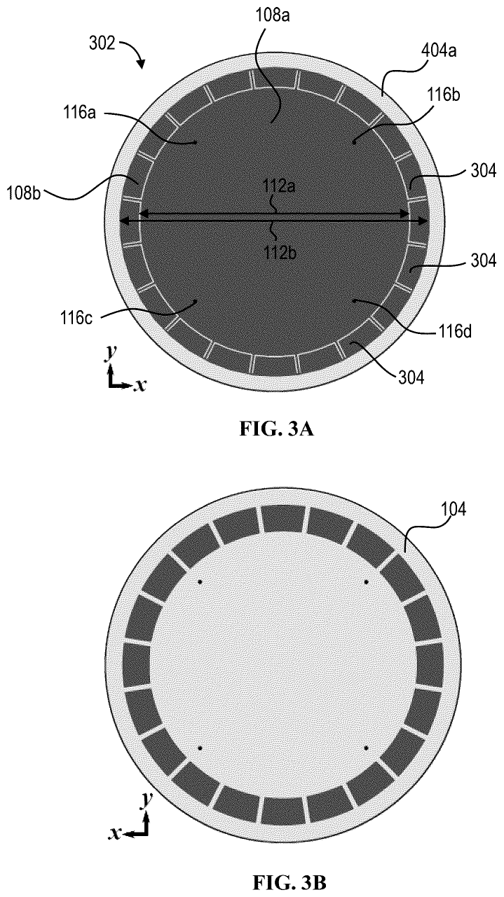

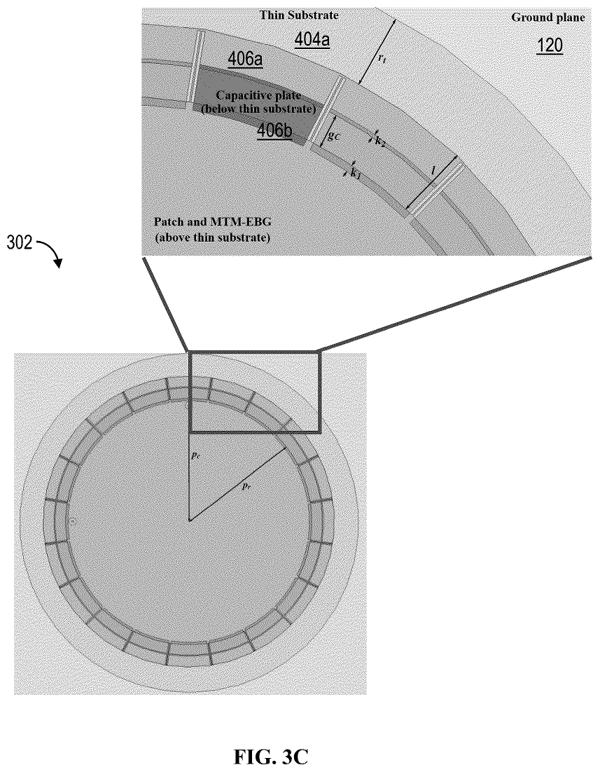

FIGS. 3-4 exemplify an antenna 302 using MTM-EBG unit cells, in accordance with disclosed examples.

As best shown in FIGS. 3A-3B, the antenna 302 includes an inner patch 108a. In the illustrated example, the inner patch 108a has a circular configuration to accommodate transmission and reception of circularly polarized signals. However, it will be understood that the inner patch 108a can have any other shape (e.g., square, rectangle, etc.), as desired.

More broadly, inner patch 108a has a cross-sectional surface area that enables the inner patch 108a to resonate at a first frequency range. In this example, the inner patch 108a has a cross-sectional surface area defined by an inner circular patch diameter (dₚ) 112a. In an example GPS application, the inner diameter 112a is dimensioned to enable to the patch 108a to resonate at the L1 frequency. In some examples, the inner diameter 112a is 76.4 mm (which operates proximal the L1 frequency), thereby maintaining nominal resonance of the patch at L1. In other examples, the inner patch 108a can be configured to resonate at any other desired frequency.

A plurality of MTM-EBG unit cells 304 surround the outer perimeter of the inner patch 108a. The MTM-EBG units cells 304 are frequency dependent, and are configured to allow the patch 108 to resonate at a second frequency range. In an example GPS application, the unit cells 302 can enable the patch to resonate at the L2/L5 frequency.

As used herein, “activating” the MTM-EBG units cells 304 refers to using the unit cells 304 at frequencies which are in a pre-configured passband of the unit cell 304. Further, “deactivating” the unit cells 304 refers to using the unit cells 304 at a frequency where the unit cell 304 presents a pre-configured electromagnetic bandgap, thereby preventing propagation of signals through the unit cells 304. As known in the art, MTM-EBG unit cells 304 are structures that can be configured to have passbands and bandgaps. This is described for example in B. P. Smyth, S. Barth, and A. K. Iyer, “Dual-Band Microstrip Patch Antenna Using Integrated Uniplanar Metamaterial-Based EBGs,” IEEE Trans. Antennas Propag., vol. 64, no. 12, pp. 5046-553 December 2016, which is incorporated herein in its entirety by reference.

When the unit cells 304 are activated, they effectively “expand” the cross-sectional surface area of the inner patch 108a to generate an expanded patch 108b having a larger cross-sectional area than the inner patch 108a. This is because when the unit cells 304 are activated, they propagate signals through, and therefore effectively function as an expansion to the inner patch 108a. For example, if the patch is circular, the expanded patch 108b has an expanded circular patch diameter (dₚ) 112b.

To this end, the larger cross-sectional area—generated by the activated unit cells 304—allows the patch 108 as a whole to resonate at a corresponding second frequency range. In some examples, the unit cells 304 are configured such that they have a bandpass frequency range that includes the second frequency range at which the expanded patch 108b resonates. In this manner, the second frequency range concurrently activates the unit cells 304, and further allows the expanded patch 108b to resonate.

In contrast, when the unit cells 304 are deactivated, the patch 108 only comprises the reduced inner patch 108a, which resonates at a corresponding first frequency range which is different than the second frequency range. In some examples, the unit cells 304 are configured to have a bandgap frequency range that includes the same first frequency range that causes the inner patch 108a to resonate. In this manner, the first frequency range concurrently deactivates the unit cells 304, and further allows the inner patch 108a to resonate.

In view of the foregoing, the use of the unit cells 304 allows the cross-sectional surface area of the patch 108 to be made a function of frequency. In turn, this allows the antenna 302 to be used for dual-band operation by activating and deactivating the unit cells 304. This is because operation at different frequencies differ only in the cross-sectional area of the patch, while all other parameters (d_{g}, h, r) can remain fixed.

In at least one example, when the unit cells 304 are activated, the expanded patch 108b is configured to allow the circular patch 108 to resonate at the L2/L5 frequency. Accordingly, the unit cells 304 have a bandpass that includes the L2/L5 frequency. In some examples, the expanded patch diameter 112b—when the unit cells 304 are activated—is 88.2 mm (which operates proximal the L2/L5 frequency), thereby maintaining nominal resonance of the patch at L2/L5. Further, when the unit cells 304 are deactivated, the remaining inner patch 108a is configured to resonate at the L1 frequency. Accordingly, the unit cells 304 have a bandgap that includes the L1 frequency. This enables the antenna 302 to operate in both the L1 and L2/L5 bands. It will be understood that while GPS frequencies are used by example, the dual-band antenna 302 can be used with any other dual bands of frequencies, including non-GPS frequencies.

In some examples, the values of the parameters (d_{g}, h, r) in antenna 302 are analogous to the dimensions provided in relation to FIGS. 1A and 1B.

In at least one example, a large number of unit cells 304 are added around the edge of the inner patch 108a. The unit cells 304 can each have the same bandpass and bandgap properties to enable the unit cells 304 to be activated/deactivated at the same frequency ranges. If the inner patch 108a is circular, the unit cells 304 can be disposed azimuthally or radially around the circular edge of inner patch 108a. By positioning the unit cells 304 to surround the entire outer edge perimeter of the inner patch 108a—when the unit cells 304 are activated, they uniformly expand the cross-sectional surface area of the patch 108 in all directions. Further, by adding a large plurality of unit cells 304 around the edge perimeter, each of the unit cells 304 can be configured in an approximately rectangular design, which facilitates the properties of the MTM-EBG unit cell to be more accurately predicted, facilitating easier design and simulation.

To this end, the phase across the exemplified circular patch 108 is approximately given by Equation (1):

$${θ}_{p} = {θ}_{o} + 2 {θ}_{m} \qquad ( 1 )$$

where θₚ is the total guided-wave phase across the patch 108 and approximately equals 180° at resonance, θₒ is the phase of the inner patch region 108a, and θₘ is the phase across one MTM-EBG unit cell 304 (the factor of two arises since the diameter of the patch includes two MTM-EBG unit cells, one on either side). In some examples, at L1, θₒ˜180° so θₘ=0° (hence the MTM-EBG bandgap), while at the arithmetic average of L2 and L5, θₒ=138° so θₘ=21° for resonance.

As shown in FIG. 3A, the inner circular patch 108a has four ports 116a-116d that function analogously to the ports 116 in FIGS. 1A and 1B, and may have a similar common pin distance (r) 118 as described above. Ports 116 are used to achieve circular polarization, and may be of equal angular spacing around the inner circular patch 108a, with successive quadrature phase. In other examples, the antenna can include one or more ports 116, as desired.

Now in more detail, as shown in FIG. 4A, the antenna 302 generally includes three primary components: (i) the primary dielectric substrate 104; (ii) an upper patch portion 402a; and (iii) a lower feed portion 402b.

Analogous to FIGS. 1A and 1B, primary dielectric substrate 104 includes upper and lower surfaces 106a, 106b, spaced along extension axis 150. Substrate 104 can have similar properties and dimensions as described in relation to FIGS. 1A and 1B, including comprising (e.g., being formed of) PLA. The use of a thicker primary dielectric substrate 104 can enable the antenna 302 to operate over greater frequency bandwidth ranges (e.g., combined L2/L5 frequency range).

The upper patch portion 402a and lower feed portion 402b are coupled to primary substrate 104 at the upper and lower surfaces 106a, 106b, respectively.

Upper patch portion 402a comprises the inner patch 108a and the MTM-EBG unit cells 304. In this example, the upper patch portion 402a includes a circuit board which includes a secondary dielectric substrate 404a. In some examples, the secondary dielectric substrate 404a is a ceramic-filled PTFE (polytetrafluoroethylene) composite, and may be of a thin dimension. For example, the secondary substrate 404a may be a thin Rogers™ RO3006 substrate. The advantage of using a ceramic-filled PTFE composite is that it has stable properties and low losses for structures at the desired frequencies. The inner patch 108a is printed over (e.g., on top) of the secondary substrate 404a, along axis 150. The MTM-EBG unit cells 304 are disposed outwardly (e.g., radially outwardly) from the inner patch 108a.

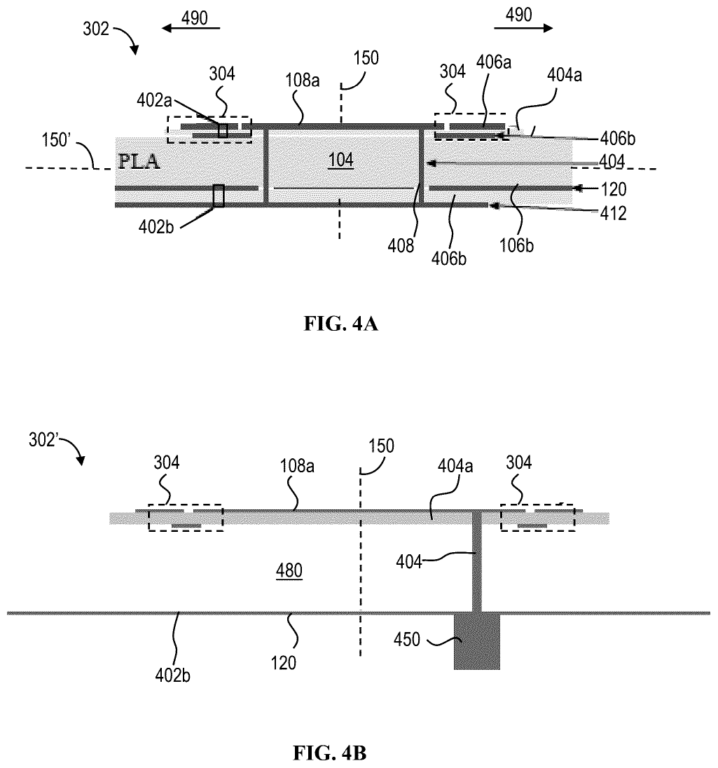

Structurally, each MTM-EBG unit cell 304 comprises a conductor-backed coplanar waveguide (CBCPW) host multiconductor transmission line (MTL), periodically loaded with reactive elements as shown in FIGS. 5A-5B. The bandgap and phase properties of the MTM-EBG unit cell 304 is made through selection of the geometric properties and reactive loading. Further, the dispersion properties of the MTM-EBG unit cell 304 are determined through Bloch analysis of a periodic set of unit cells. In at least one example, each of the MTM-EBG unit cells 304 is designed to have the properties discussed in relation to Equation (1) using a Bloch analysis of the MTM-EBG unit cell.

In at least one example, dimensionally, and in reference to FIG. 5A, the MTM-EBG has geometric parameters of D=5.9 mm, W=12.8 mm, s=0.4 mm, g1=0.5 mm, and g2=0.5 mm; the width was chosen so that exactly 20 unit cells are placed azimuthally along the patch edge. The unit cell 304 can be loaded with capacitors of C=1.33 pF and small inductors of L=0.2 nH. To this end, this novel implementation of the MTM-EBG unit cell 304 is well suited for an application in an antenna with a PLA substrate since the PLA is not copper-plated, and a thin substrate is required to support the patch itself; adding capacitive plates to the underside of this substrate adds little additional complexity. If a thin substrate is used, choice of the material affects the parallel-plate capacitance of the MTM-EBG, but will have a negligible effect on the antenna resonance frequency, which is mainly dependent on the PLA. As shown in FIG. 5A, in at least one example, an h₂=0.254 mm thick Rogers 3006 substrate (ϵᵣ=6.15, tan δ=0.002, clad in ½-oz copper) was chosen, and the required reactances were achieved with dimensions of a₁=0.4 mm, a₂=5 mm, and a₃=1.7 mm (FIG. 5A).

In the illustrated example (FIG. 4A), the physical implementation of the unit cell 304 is achieved without the need for discrete chip capacitors and inductors by realizing them in printed form. The small inductances are replaced by small metallic strips (e.g., having a width a in FIG. 5A). Further, a parallel-plate capacitor design is used on either side of the secondary substrate 404a. The parallel-plate capacitor includes: (i) an upper patch segment 406a (fabricated above the secondary substrate 404a) that is spaced outwardly from the inner patch 108a, and (ii) a lower capacitive plate 406b (fabricated below the secondary substrate 404a), and which may extend between inner patch 108a and the upper patch segment 406a. Structures 404a, 406a, 406b extend along a lateral axis 150′ (e.g., radial axis) that is orthogonal to extension axis 150. The outward direction 490 refers to a direction towards the edge of the antenna structure 302.

FIG. 5C illustrates a cross-sectional view of a single MTM-EBG unit cell 304 to further clarify its mode of operation. As shown, each unit cell 304 includes: (i) on one side of the substrate 404a, the upper patch segment 406a outwardly spaced from the inner patch 108a. Each of the inner patch 108a and upper patch segment 406a effectively individually define a corresponding capacitive plate; and (ii) on the opposing side of the substrate 404a (i.e., along extension axis 150) the lower capacitive plate 406b which extends continuously to overlap (i.e., along axis 150) beneath the upper patch segment 406a and the inner circular patch 108a. The length of overlap, as between the lower capacitive plate 406b and the circular patch 108a, is shown as overlap region 504a. Further, the length of overlap between the lower capacitive plate 406b and the upper patch segment 406a, is shown as overlap region 504b. In view of the foregoing, a multi-layer design configuration is used for the unit cell 304.

As shown, a gap 502 (e.g., a radial gap) separates the upper patch segment 406a of each unit cell 304, from the inner patch 108a. Here, it is appreciated that an outer portion of the inner patch 108a (e.g., a radially outer portion) forms a part of each unit cell 304.

The effect of this design for the unit cell 304 is that, when an electric signal is applied to the unit cell 304, the unit cell 304 effectively generates two parallel-plate capacitors 550a, 550b (FIG. 5C). The first capacitor 550a is formed between the inner patch 108a and the lower capacitive plate 406b. The second parallel-plate capacitor 550b is formed between the upper patch segment 406a and the lower capacitive plate 406b. The two “capacitors” 550a, 550b are configured in series because of the mutual lower capacitive plate 406a.

An appreciated advantage of this configuration—using a unit cell 304 with a two-layer capacitor arrangement across a thin dielectric substrate 404a, as described—is that the implementation of each unit cells 304 allows larger capacitance and greater flexibility in choosing the operating frequencies at which the unit cell 304 can be activated and/or deactivated (e.g., for selective dual-band operation of the antenna). This is contrasted, for example, to designs that use a single layer capacitor (e.g., a single interdigitated layer).

As will be understood, various geometric aspects of the unit cell 304 can be varied to vary the operating frequencies. For example, the length of the overlapping regions 504a, 504b can be varied to modify the corresponding capacitances 550a, 550b to achieve more control over the bandgap/bandpass at desired operating frequencies. The overlapping regions 504a, 504b can be varied by extending the radial length of the lower capacitive plate 406b, the inner patch 108a and/or the upper patch segment 406a.

To this end, the use of MTM-EBG unit cells 304 is appreciated to be especially useful for integration into planar structures of fixed electrical size since they are electrically small, uniplanar, and have a predictable bandgap and phase response, due to analysis of its properties using multiconductor transmission line (MTL) theory. It is also notable that even a single unit cell closely approximates the results of the Bloch analysis.

Referring back to FIG. 4A, the lower feed portion 402b may comprise a solid ground plane 120 and the feed network circuit 412. As explained herein, the feed network circuit 412 is used to feed the electrical signals to the antenna output ports 106, e.g., during signal transmission. It is understood, however, that the feed network circuit 412 is also used to receive signals during signal reception (e.g., receiving circularly polarized signals via the antenna input ports 116).

In this example, the lower feed portion 402b, of antenna 302, includes another circuit board which includes a secondary dielectric substrate 404b. The solid ground plane 120 is fabricated on the upper surface of the secondary substrate 404b, while the feed network circuit 412 is fabricated on the lower surface of the substrate 404b. In other cases, this configuration can be reversed.

Substrate 404b may be of the same or differential material from substrate 404a, i.e., of the upper patch portion 402a. In some examples, substrate 404b is approximal 50 mil (approximately 1.27 mm) in axial height, and may be formed of ceramic-filled PTFE composite substrate (e.g., a Rogers™ RO3006 substrate).

As further shown, the inner circular patch 108a is fed by one or more feed pins 404. Each feed pin 404 couples between the feed network circuit 412 and a respective port 116 on the inner patch 108a. The feed pins 404 function to carry (e.g., transmit) signals from the feed network 412 to the ports 106, and vice-versa.

In some examples, the feed pins 404 extend parallel to axis 150. To this end, there may be more one or more feed pins 404 in the antenna 302. More generally, there are an equal number of feed pins 404 as ports 116. In cases where four output ports 116 are provided (FIGS. 3A and 3B), a feed pin 404 is provided for each port 116.

In at least one example, each feed pin 404 is formed (e.g., comprises) conductive material, such as copper. As shown in FIG. 3A, there are four feed pins 404 coupled to four ports 116. The four ports 116 having excitations of equal magnitude and appropriate quadrature phase to allow for circular polarized signals. The feed pins 404 pass through circular apertures 408 formed within the primary substrate 104, as well as each of the secondary substrates 406a, 406b. In at least one example, the feed pins 404 and corresponding apertures have a radius of approximately 2 mm. In some examples, a spacing is formed in the ground plate 120 to accommodate the feed pins.

In view of the foregoing, the disclosed antenna structure has a low-profile, and uses cheap 3D printed substrate ensures it is low cost.

### IV. Feed Network Circuit Configuration

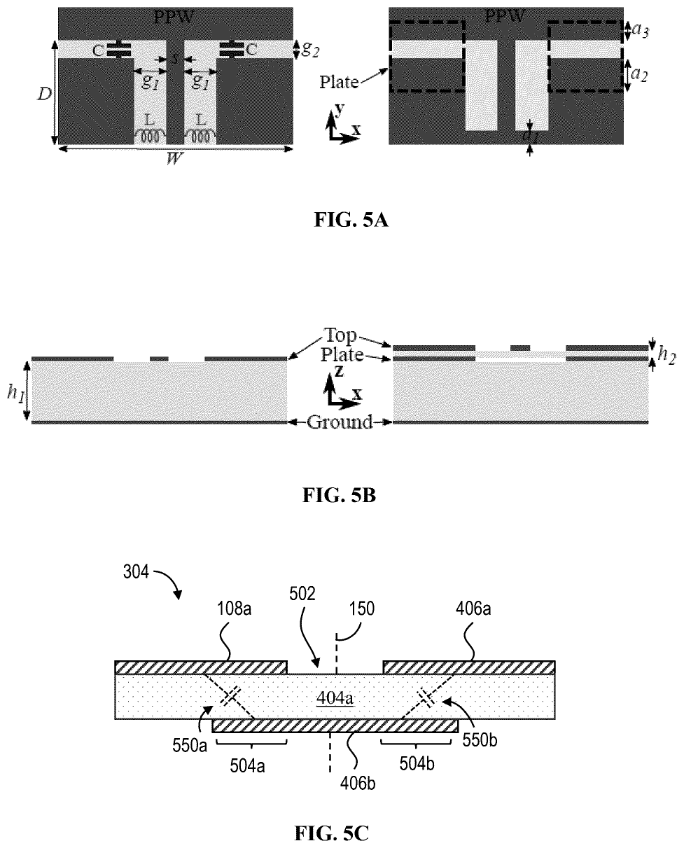

FIG. 6A shows an example simplified hardware circuit diagram of the feed network circuit 412 configuration. The feed network circuit 412 can be fabricated on the secondary substrate 406b, used in the lower feed portion 402b (FIG. 4A).

As shown, the feed network 412 uses a single input/output port 602, and operates as a four-way power divider with a phase differential of 90° applied at each successive port 116a-116d. As described herein, the feed network 412 can be formed using a microstrip-based circuit. In at least one example, the GPS antenna is fed into the input port 602 from an input source (not shown), which can be a single standard subminiature A (SMA) cable in an edge-launch configuration.

To this end, in order for the feed network 412 to provide the required phase and amplitude at all three GPS bands, the network is configured as either multi-band or broadband (with about a 30% bandwidth).

In disclosed examples, the feed network 412 comprised a broadband network. A broadband network can be selected since many components are available with such bandwidths, and the feed network, which includes many components, is less frequency-sensitive as a result. More generally, the microstrip-based feed network 412 is designed over a solid ground plane 120 which may be used as a common ground with the antenna, while isolating each part from the other. The size of the antenna ground plane then depends partially on the size of the feed network 412.

As illustrated in FIG. 6A, the designed feed network 412 includes three quadrature hybrid couplers (QHCs) 604a-604c and one differential phase shifter (DPS) 606.

The input port 602 feeds into the first QHC 604a, which is in turn coupled to the DPS 606. The DPS 606 is then coupled to each of the second and third QHC's 604b, 604c. The first and second output ports 116a, 116b are coupled to the second QHC 604b, while the third and fourth outputs 116c, 116d are coupled to the third QHC 604c. The resulting output phase from each of the QHC's and DPS, as well as at the outports 116a-116d is shown in FIG. 6A. As shown, the output ports 116a-116d generate output signals at 90° differentials, which can be used for generating circular polarized signals.

As best shown in FIG. 6B, the broadband coupler can be designed based on a multi-loop circuit resembling a quadrature hybrid coupler with an extra branch, and miniaturized through meandering of some of the constituent transmission line segments. The differential phase shifter (DPS) can be designed based on S. Y. Zheng, W. S. Chan, and K. F. Man, “Broadband phase shifter using loaded transmission line,” IEEE Microw. Wireless Compon. Lett., vol. 20, no. 9, pp. 498-500, 2010, the entirety of which is incorporated herein by reference. In at least one example, both the QHC and DPS are designed on a 50 mil Rogers 3006 secondary substrate 406b, which offers a good tradeoff between miniaturization of components and reasonable transmission line widths.

In at least one example, the QHCs and DPS are tuned individually before they are combined into the final layout that feeds the GPS antenna 302 at the prescribed pin positions. In some examples, the transmission line segments that lead to the pin locations are all of equal length to preserve the relative port phasing, and the overall substrate diameter is 146 mm. The input port extends to a flat edge protruding from the circular substrate to enable feeding with an SMA cable.

In some examples, the QHC requires segments of high-impedance transmission lines with a width of 0.15 mm. This dimension is realizable with some PCB-printing technologies, such as laser etching. The QHC can also be planar except for a 50Ω resistor that is required to prevent reflections from the isolated port, and a via to ground the resistor.

FIG. 6C shows the QHC 604 and DSP 606 circuit configuration in greater detail, and being annotated with various dimensions. Table 1 provides example dimensions used for the QHCs 604 and DSP 606, with reference to FIG. 6C.

TABLE 1
Feed Network Dimensions with Units in Millimeters (mm)

| | | | |
|---|---|---|---|
| r = 32.00 | r₁ = 4.64 | r₂ = 9.64 | r₃ = 25.00 |
| l₁ = 30.58 | l₂ = 34.77 | w₁ = 1.78 | w₂ = 3.50 |
| w₃ = 0.15 | w₄ = 2.31 | w₅ = 3.30 | w₆ = 1.78 |
| c₁ = 6.57 | c₂ = 8.67 | c₃ = 2.04 | c₄ = 6.66 |
| c₅ = 26.40 | c₆ = 6.41 | c₇ = 6.81 | p₁ = 15.84 |
| p₂ = 37.70 | p₃ = 23.98 | p₄ = 9.87 | p₅ = 23.98 |
| p₆ = 42.77 | p₇ = 12.15 | p₈ = 34.41 | |

### V. Example Method of Fabricating Antenna

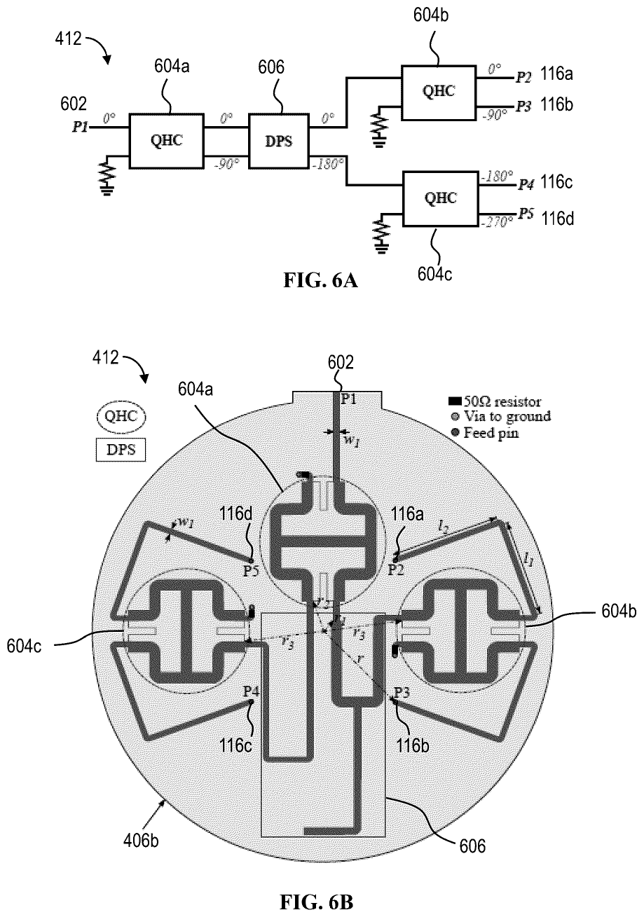

FIG. 7 shows a process flow for an example method 700 for fabricating the disclosed antenna 302.

At 702, the upper patch portion 402a (FIG. 4A) (e.g., the patch/MTM-EBG layer) is fabricated on the required thin substrate 404a. In at least one example, this fabrication is performed using a LPKF Protolaser™ U3 laser milling system for etching, and LPKF ProtoMat™ S62 for routing and drilling holes in the pin locations.

At 704, the lower feed portion 402b (FIG. 4A) (e.g., the feed network/ground plane layer) is fabricated similarly over a ground plane 120, with apertures through which the feed pins 404 can pass. In some examples, metallic vias, resistors, and SMA connectors are added manually.

At 706, the primary substrate 104 is fabricated (FIG. 4A). In some examples, the primary substrate is formed of PLA. This can allow the substrate to be 3D printed, at 706, to the appropriate size, leaving holes for the feed pins 404 to pass through.

At 708, the antenna 302 is assembled with the soldering of feed pins 404 to the upper patch portion 402a and lower feed portion 402b, with primary substrate 104 in between, completing the electrical connection and providing rigidity. In some examples, the feed pins comprise copper wires.

At 710, in at least one example, an adhesive is used for a greater bond between layers.

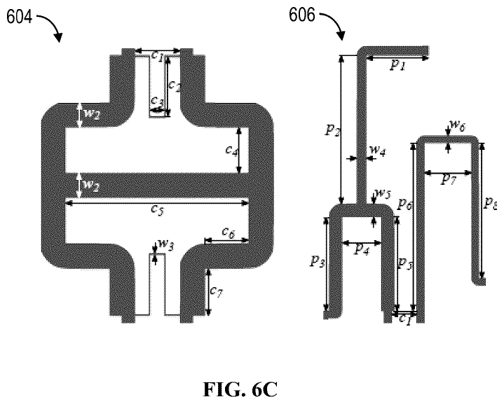

FIGS. 8A and 8B provide photographs of the example fabricated antenna.

### VI. Simulation Results

The following is a discussion of various test simulations conducted on the antenna 302, or portions thereof, based on GPS L1 and L2/L5 frequencies.

### (i) MTM-EBG Unit Cells.

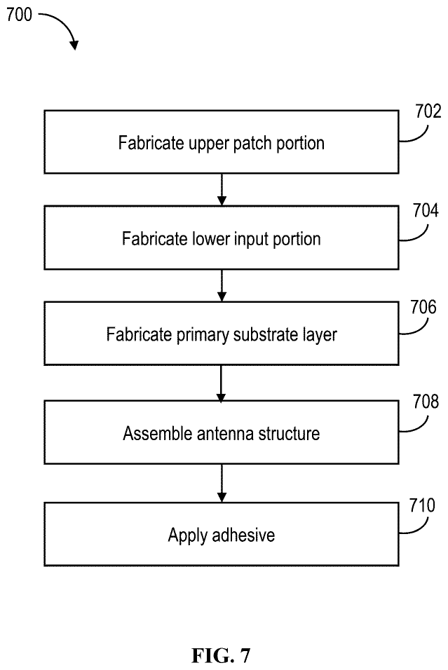

To verify the correct properties were obtained, a simulation of the unit cell 304 embedded in a parallel-plate environment (to simulate the fields encountered in a patch antenna) was conducted. The bandgap and phase response of the unit cell are presented in plots 900a and 900b of FIGS. 9A and 9B, respectively, where it is evident that the designed properties are observed.

### (ii.) Reflection & Radiation Characteristics.

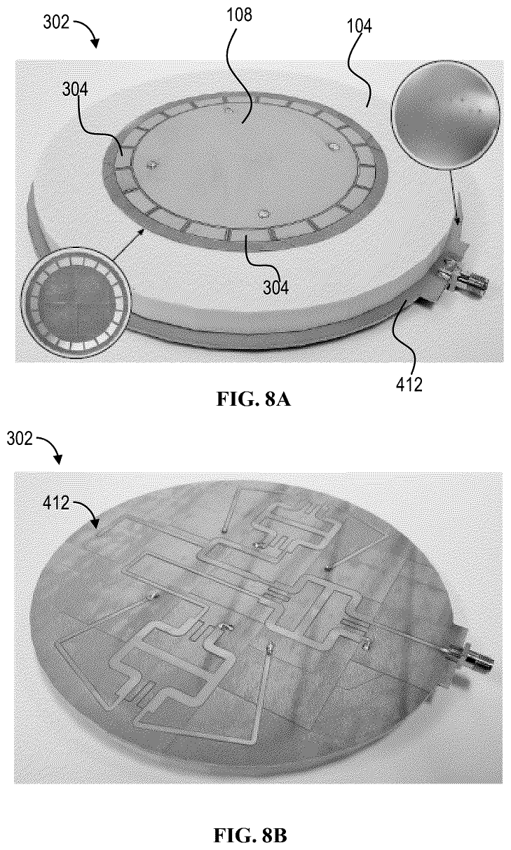

The antenna 302 using four ports was simulated using Ansys HFSS™, and the reflection coefficient is presented in plot 1000a of FIG. 10A. P(Y)-code reception bandwidths of +12 MHz around all frequency bands are highlighted, and good matching is observed around each band, with the lower band effectively covering not just GPS L2 and L5, but also other GNSS bands in that frequency range.

Gain patterns showing co-polarization (RHCP) and cross-polarization (LHCP) are provided for the antenna at each operating frequency in FIG. 10B; only a single cut of the pattern (¢=0) is shown due to azimuthal symmetry. For the ideal excitation of equal magnitude and quadrature phase at each port, excellent polarization purity is achieved, and RHCP gains of greater than 5 dB are observed at broadside at all frequencies, with radiation efficiency of 54.7%/82.8%/83.7% and 3-dB beamwidths of 78°/86°/88° at L1/L2/L5, respectively. RHCP gain 10° above the horizon ranges from −5.3 dBi to −3.3 dBi. AR is plotted in FIG. 10C and excellent performance is observed; polarization purity will therefore be dictated by performance of a realistic feed, as the antenna performs well in the ideal case.

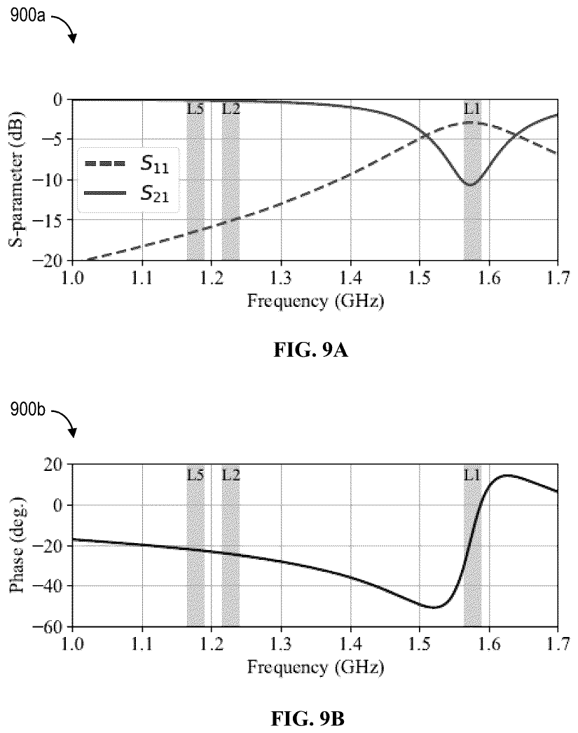

Ground plane size will affect the radiation characteristics of the GPS antenna. For the presented results, a ground plane of d_{g}=146 mm was used, but there may be cases in which a smaller ground plane (e.g., stand-alone miniaturized antenna) or a larger ground plane (e.g., antenna mounted on metallic body of vehicle or aircraft) are required. A study of gain versus ground plane size is thus conducted, and results are presented in plot 1100 of FIG. 11. Increasing the ground plane size results in increased broadside RHCP gain as the beam is narrowed slightly; however, gain remains sufficiently high even as the ground plane shrinks, although the reduction in gain is attributed to increased LHCP radiated downwards, and worse multi-path performance as a result

### (iii.) Feed Network Performance.

Performance in each band is compared in Table 2, which allows specific values of power division and relative phase to be easily compared.

TABLE 2
Feed Network Performance

| | Goal | L1 | L2 | L5 |
|---|---|---|---|---|
| \|S₁₁\| [dB] | <−15 | −22.18 | −15.66 | −15.77 |
| \|S₂₁\| [dB] | −6.02 | −6.31 | −6.43 | −6.77 |
| \|S₃₁\| [dB] | −6.02 | −7.00 | −6.95 | −6.94 |
| \|S₄₁\| [dB] | −6.02 | −6.50 | −6.42 | −6.45 |
| \|S₅₁\| [dB] | −6.02 | −7.22 | −6.93 | −6.57 |
| ∠S₃₁ − ∠S₂₁ [deg.] | −90.0 | −88.9 | −88.1 | −88.9 |
| ∠S₄₁ − ∠S₂₁ [deg.] | −180.0 | −176.9 | −174.7 | −174.2 |
| ∠S₅₁ − ∠S₂₁ [deg.] | −270.0 | −265.9 | −262.8 | −263.2 |

The first row of data shows that the feed is well matched, with return loss greater than 15 dB in all bands. Next, the feed network is designed for equal power division each port, so the following four rows provide |Sₙ₁| in dB, where n=(2, 3, 4, 5) are the four output ports; the absolute difference in insertion loss at the four output ports is 0.5 dB at L2/L5 and 0.9 dB at L1. The remaining rows present phase shift referenced to port 2, which each successive port adding an additional phase lag of 90°. In all bands, port 3 is within 2°, port 4 is within 6°, and port 5 is within 8° of the design phase value. These deviations from the expected phase will degrade axial ratio to some extent, but the deviations are small enough that an acceptable AR is still anticipated.

Good broadband performance of the feed network suggests that it is a good candidate to feed the proposed GPS antenna. Combination of the feed and antenna follow, with simulated and experimental results

### (iv.) Measurement.

The GPS antenna was measured both with a vector network analyzed (VNA) and in an anechoic chamber to fully characterize its properties.

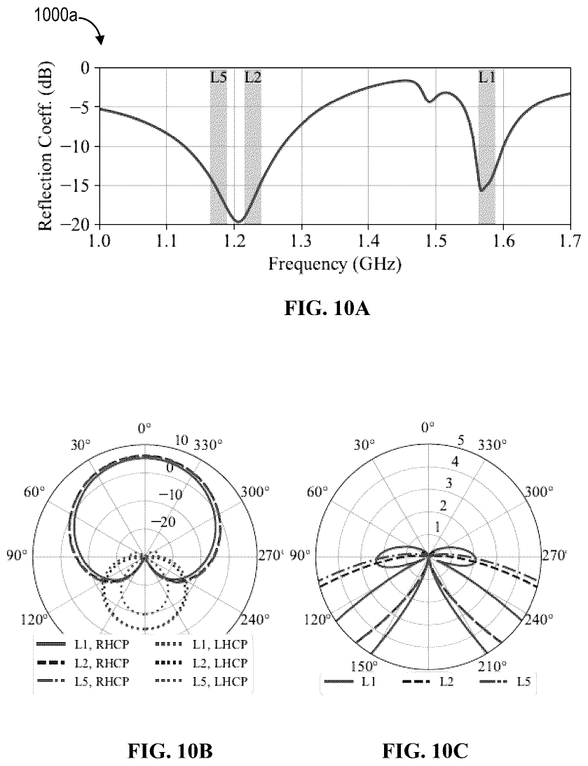

First, the reflection coefficient of the antenna with the feed network is presented in plot 1200 of FIG. 12. Matching greater than 10 dB is observed over all three GPS bands in simulation and measurement, although the clear dual band operation is obscured by losses in the feed network at frequencies where the antenna is not matched; reflected power is dissipated in the QHC resistors. Realized gain can instead be used as a metric to determine the frequencies at which the antenna is radiating.

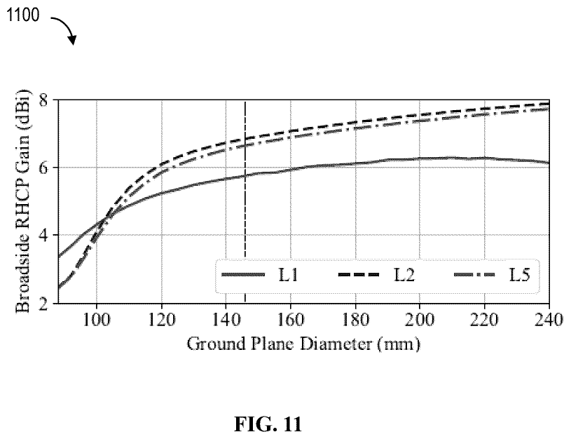

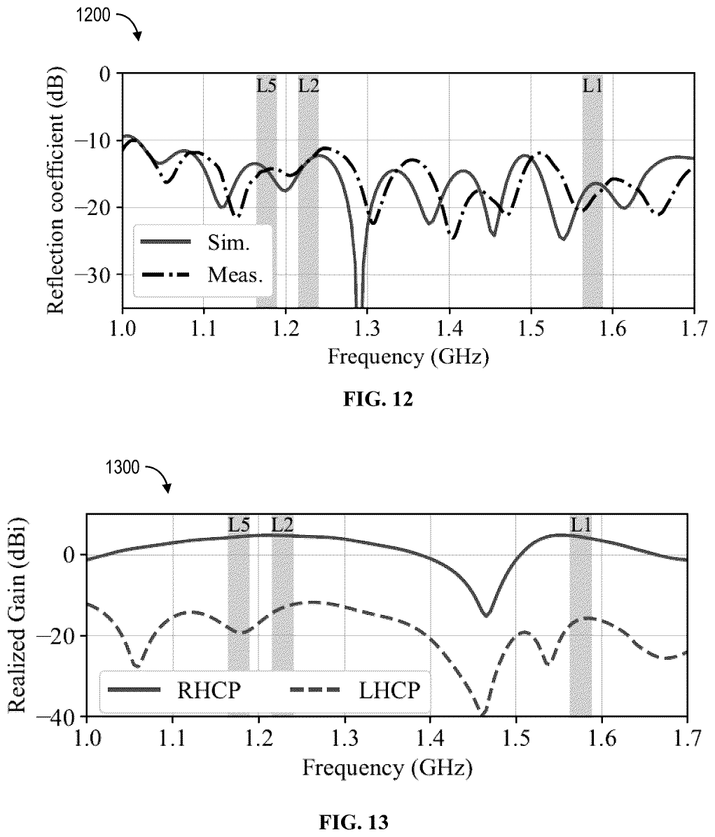

Broadside realized gain for the simulated antenna with feed network is plotted in plot 1300 of FIG. 13. Available facilities did not have the ability to accurately measure gain for comparison, however, normalized radiation patterns were measured in an anechoic chamber, and are presented in FIGS. 14A-14C. Results on the xz-plane, which includes the SMA connector, are plotted in the left column, and the yz-plane on the right; good agreement in pattern shape, particularly for RHCP, is observed. The increase in LHCP is caused by the imperfect phase response of the feed network, and disagreements between simulation and measurement arise from the presence of cables and stands used to measure the antenna.

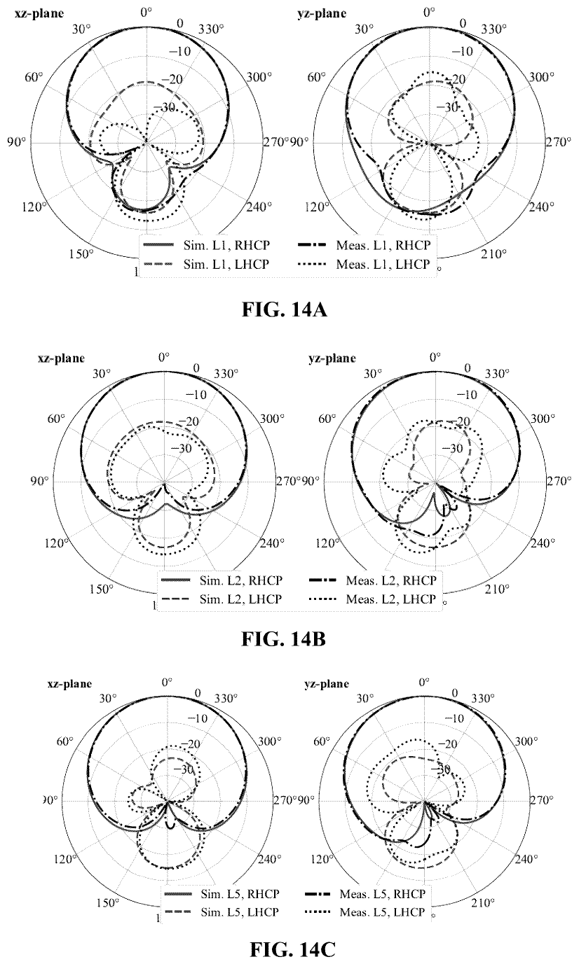

Despite increased cross-polarization, reasonable AR is maintained in the upper hemisphere; simulated and measured results of AR patterns are provided in FIGS. 15A-15C. Plots are in the yz-plane so as not to include the SMA connector, but similar results are observed in either Axial ratio is generally near or below 2 dB for most of the upper hemisphere, although tends to increase near the horizon. This is particularly apparent in measurement results, and may be attributed to spurious radiation from cables used in the measurement setup. Another metric of interest is the multi-path ratio (MPR), which is defined as:

$$M P R = \frac{R H C P ( θ )}{L H C P ( 180 ° - θ )} \qquad ( 1 )$$

Measured MPR is greater than 10 dB in all bands for nearly all of the upper hemisphere; the worst case is for L1, where MPR is greater than 10 dB for any θ<82°. It could be improved with a larger ground plane, or else with a choke-ring type structure that reduces the antenna back lobes.

### VII. Alternative and Specific Examples

### (i) MTM-EBG Unit Cells.

While the disclosed MTM-EBG unit cells 304 are exemplified with use with a dual-band antenna, it will be understood that the cell units 304 can be integrated into any other device or structure. Further, the disclosed unit cell 304 structure may be integrated with various non-radiating devices (e.g., power dividers, couplers, feed networks, filters, and cross-overs) which could benefit from the two-layer capacitive MTM-EBG unit structure disclosed herein. More generally, the disclosed MTM-EBG unit cells can also be used individually and/or together as stand-alone components.

### (ii.) Multi-Band Antenna Design.

It will also be appreciated that the same concepts disclosed herein may be applied to fabricate a multi-band antenna. In these cases, more layers of MTM-EBG unit cells are added around the perimeter of the patch to accommodate additional frequency bands. For instance, by way of non-limiting example, a first layer of cells may encircle around the outer permitter of the inner patch, a second layer of cells may encircle around the outer perimeter of the first layer, and so forth. In this manner, the layers of unit cells are sequentially more distal from the inner patch. The unit cells in each layer may be configured with different activation/deactivation frequencies to enforce additional resonances and correspondingly produce additional operating frequency ranges for the antenna.

### (iii.) Antenna Structure.

FIG. 4B shows another example configuration of the antenna structure 302′.

Antenna 302′ is generally analogous to antenna 302, with the exception that antenna 302′ does not include the primary substrate 104 and the feed network circuit 406. In this example, the primary substrate 104 is substituted for an air dielectric 480. Further, only a ground plane 120 is provided in the lower portion 402b (e.g., no secondary substrate 406b or feed network 406 is provided in the lower portion 402b). The upper and lower portions 402a, 402b are on either sides of the air dielectric 480, e.g., along axis 150.

In some examples, to achieve an appropriately large 10-dB bandwidth of 5.9% in the lower band, an air dielectric with a height of 14 mm is used. The patch itself can be mounted on a thin dielectric sheet that provides rigidity, and printing on both sides of the sheet enables large, printed capacitances to be realized without the need for any surface-mount reactive components or vias; the antenna thereby maintains a low profile, and the fabrication process is simplified. In some examples, the patch has a diameter of 12.3 cm, which is smaller than a conventional circular patch with the same dielectric operating at L5.

In this example, each feed pin 404 can be directly coupled to an input source 450 (e.g., a coaxial cable feed), rather than the feed network 406. Any number of feed pins 404 may be provided, coupled to corresponding input sources 450. In some examples, four input sources 450 are provided, with a corresponding phase offset such that circular polarization can be generated from four output ports 116 on the inner circular patch 108a, as discussed previously.

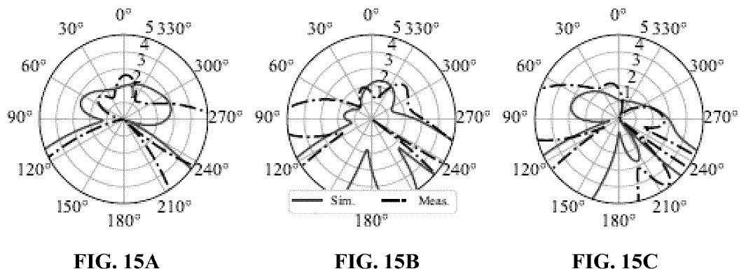

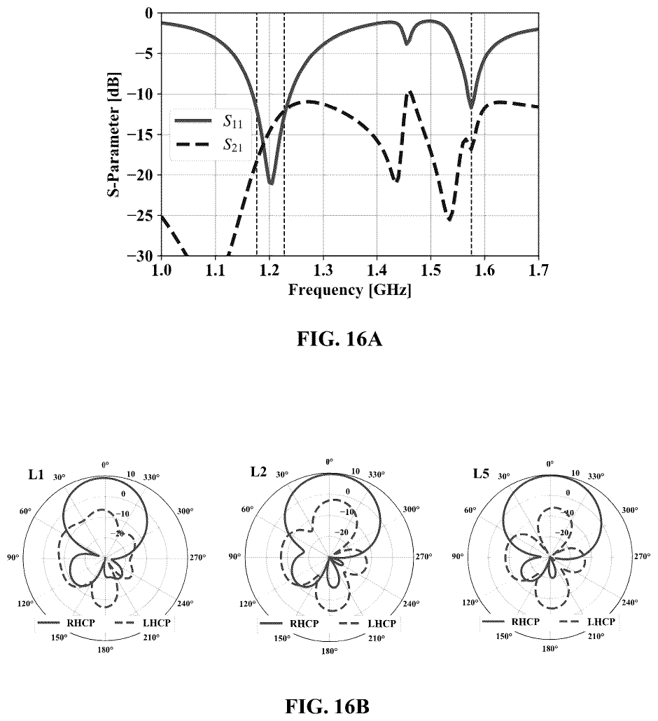

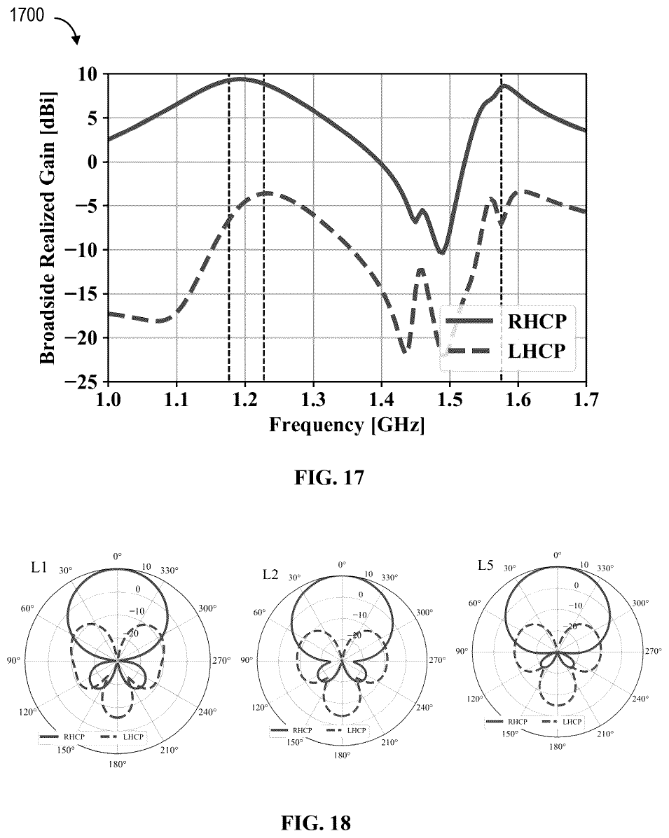

FIGS. 16-18 show various plots using the configuration of antenna 302′, and providing four output ports 116 (as illustrated in FIG. 3A), and corresponding feed lines. Table 3 shows various performance parameters.

TABLE 3
Performance Parameters

| | L1 | L2 | L5 |
|---|---|---|---|
| Return Loss | 11.6 dB | 12.8 dB | 11.9 dB |
| Isolation | 16.8 dB | 12.1 dB | 18.4 dB |
| Broadside Gain | 8.9 dBi | 9.4 dBi | 9.6 dBi |
| Realized Gain | 8.5 dBi | 8.9 dBi | 9.3 dBi |
| 3-dB Beamwidth | 49° | 54° | 58° |
| Axial Ratio | 2.9 dB | 4.2 dB | 2.8 dB |
| Efficiency | 71.6% | 97.5% | 98.3% |

If the structure of antenna 302′ is used, then in method 700 (FIG. 7), acts 704 and 706 may be omitted. For example, the antenna 302′ can be assembled only by fabricating the upper patch portion 702, and only using a ground plane 704 for the lower feed portion 704.

In other examples, the antenna can be similar to antenna 302, only with the exception that no primary substrate 104 is provided, and only an intermediate air dielectric 480 is provided between the upper and lower portions 402a, 402b, as shown in FIG. 4A.

### VIII. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. An antenna structure comprising:
an inner patch;
a plurality of metamaterial based electromagnetic bandgap (MTM-EBG) unit cells disposed along an outer perimeter of the inner patch, each unit cell being configurable between an activated state and a deactivated state, each unit cell comprising a two layer parallel plate capacitive arrangement defined by,
a dielectric substrate extending between a first surface and a second surface along an extension axis,
two first capacitive plates fabricated along the first surface and separated by a gap, and
a second capacitive plate fabricated along the second surface and overlapping with the first capacitive plates in a direction along the extension axis,
wherein when the unit cells are deactivated, the inner patch is configured to resonate at a first frequency range, and when the unit cells are activated, the inner patch with the unit cells are configured to resonate at a second frequency range.

2. The antenna of claim 1, wherein the two first capacitive plates and the second capacitive plates together form two capacitors in series formation, and lie in parallel to a gap capacitance formed by the two first capacitive plates.

3. The antenna of claim 1, wherein the inner patch is circular or rectangular, and the unit cells are disposed around an outer edge of the patch.

4. The antenna of claim 1, wherein each MTM-EBG unit cell is configured with a passband frequency range that includes the second frequency range, and a stopband frequency range that includes the first frequency range.

5. The antenna of claim 4, wherein each MTM-EBG unit cell is activated when a signal in the second frequency range is applied to each unit cell, and is deactivated when a signal in the first frequency range is applied to each unit cell.

6. The antenna of claim 1, wherein the first frequency range include an L1 GPS frequency range, and the second frequency range includes an L2 and/or L5 GPS frequency range.

7. The antenna of claim 6, wherein the inner patch has a first diameter configured for resonating at the L1 frequency, and the MTM-EBG unit cells are deactivated at the L1 frequency range.

8. The antenna of claim 7, wherein at the L2 or L5 frequency, the MTM-EBG unit cells are activated to produce an expanded patch having a second diameter configured to resonate at the L2 or L5 frequency, the second diameter being wider than then first diameter.

9. The antenna of claim 1, comprising a patch portion that includes the inner patch and the plurality of MTM-EBG unit cells.

10. The antenna of claim 9, wherein the patch portion includes the dielectric substrate, and wherein the inner patch forms a portion of one of the first capacitive plates.

11. The antenna of claim 9, further comprising a primary dielectric substrate having a first and second surface, and the patch portion is coupled to the first surface, and the second surface is coupled to a feed portion.

12. The antenna of claim 11, wherein the primary dielectric substrate comprises one or more of polylactic acid (PLA), a foam spacer, and an air gap forming an air substrate.

13. The antenna of claim 11, wherein the feed portion comprises a ground plane and a feed network circuit.

14. The antenna of claim 13, wherein the feed portion comprises a secondary dielectric substrate, and the ground plane and feed network circuit are fabricated on opposing surfaces of the secondary dielectric substrate.

15. The antenna of claim 14, wherein at least one feed pin couples between the feed network circuit and the inner patch.

16. A metamaterial based electromagnetic bandgap (MTM-EBG) unit cell comprising a two layer parallel plate capacitive arrangement defined by:
a dielectric substrate extending between a first surface and a second surface along an extension axis,
two first capacitive plates fabricated along the first surface and separated by a gap, and
a second capacitive plate fabricated along the second surface and overlapping with the first capacitive plates in a direction along the extension axis,
wherein the unit cell is deactivated when a signal in a first frequency range is applied, and activated when a signal in a second frequency range is applied.

17. The unit cell of claim 16, wherein the two first capacitive plates and the second capacitive plates together form two capacitors in series formation, and lie in parallel to a gap capacitance formed by the two first capacitive plates.

18. The unit cell of claim 16, wherein the unit cell is configured with a passband frequency range that includes the second frequency range, and a stopband frequency range that includes the first frequency range.

19. A method of fabricating an antenna structure comprising:
fabricating a patch portion comprising an inner patch and a plurality of metamaterial based electromagnetic bandgap (MTM-EBG) unit cells disposed along an outer perimeter of the inner patch;
fabricating a primary substrate;
fabricating a feed portion comprising a ground plate layer and a feed network circuit; and
coupling the patch portion and feed portion to opposing surfaces of the primary substrate.

20. The method of claim 19, wherein the substrate comprises one or more of polylactic acid (PLA), a foam spacer, and an air gap forming an air substrate.
